(19) United States
(12) Patent Application Publication
(10) Pub. No.: US 2006/0235564 A1
(43) Pub. Date: Oct. 19, 2006

(54) Method and multifunctional system for producing laser-induced images on the surfaces of various materials and inside transparent materials

(76) Inventor: Igor Troitski, Henderson, NV (US)

Correspondence Address: IGOR TROITSKI, 853 ARROWHEAD TRAIL, HENDERSON, NV, 89015, US

(21) Appl. No.: 11/108,121

(22) Filed: Apr. 18, 2005

(51) Int. Cl. B23K 26/00; G06F 19/00

(52) U.S. Cl. 700/166; 219/121.69; 219/121.68

(57) ABSTRACT

The present invention discloses the methods and the multifunctional systems which are capable to produce the laser-induced images both on the surfaces of the various materials and inside the transparent materials. The method and multifunctional system are based on using different kinds of the laser-material interaction including: heating, melting, vaporization, material removal by shock waves, breakdown and photoionization. The method and system can also use a combination of the laser-material interaction effects and provide creating images containing marks of the different optical properties. The method includes the selection of the needed kinds of laser-material interaction, determination of laser radiation parameters for generation of desirable interaction kind and transformation of the original image into corresponding arrangements of points at which the needed laser-material interaction is generated. The multifunctional system disclosed in the invention can be used for hands-free operation and for manual art work.

### FIELD OF THE INVENTION

The present invention relates to methods and systems for producing laser-induced images on the surfaces and/or inside materials by using pulsed laser radiation.

### BACKGROUND OF THE INVENTION

Creation of images on the surface or inside materials is realized by the local change of their optical properties in accordance with the given images. Production of a surface image is carried out by the local change of the reflection characteristics of the surface; creation of an image inside transparent materials is accomplished by generation of scattering or absorbing centers inside these materials. Space resolution of the images is determined by the sizes of the areas which correspond to the local changes.

The use of laser radiation for creation of the images called laser-induced images is possible due to the interaction effects of high-power laser radiation with the materials. Interaction of laser radiation with material causes (induces) heating, melting, vaporization and shocking. Especial place in the row of the interaction effects occupies laser-induced breakdown which is generated by focused pulsed laser radiation inside transparent materials (mediums) and which is accompanied by the creation of high-temperature plasma and shock waves. As a result of the interaction effects, the reflection characteristics of the surface can be changed and scattering (or absorbing) centers can be generated inside transparent materials.

There are a number of techniques for creation of images on surfaces and inside material by using the laser-material interaction effects.

U.S. Pat. No. 3,941,973 to Luck, Jr., et al. reveals an apparatus for laser material removal from a work piece wherein optical means is provided for compressing portions of the beam.

U.S. Pat. No. 4,001,840 to Becker, et al. provides a method and apparatus for laser image recording. The recording medium comprises thin metallic films carried on flat substrates.

U.S. Pat. No. 4,032,861 to Rothrock discloses a laser device for altering surfaces in accordance with given patterns. The alteration may take the form of actual vaporization, heating, or oxidation of portion of the surface.

U.S. Pat. No. 4,092,518 to Merard discloses a method of decorating a transparent plastics material article by means of a laser beam. Pulse energy and pulse duration are selected in dependence upon the desired extent of the decorative features.

U.S. Pat. No. 4,200,875 to Galanos concerns apparatus for recording and viewing laser-made images on high gain retro reflective sheeting. The recorded image can be seen only when the target is inclined at the same angle at which the target was positioned when the pattern was recorded by the laser light beam radiation on the target.

U.S. Pat. No. 4,335,295 to Fowler relates to a method of marking a metal device. The method includes the steps of locally heating a specified area of the metal, so that its microstructure is altered.

U.S. Pat. No. 4,734,550 to Imamura, et al. proposes a laser processing method for scribing the surface of a work piece with a pulsed laser beam to form grooves therein.

U.S. Pat. No. 4,843,207 to Urbanek, et al. discloses method and apparatus for selective creation of a decor on hollow axially-symmetric products by a laser beam. A laser beam with a wavelength of the spectrum between 0.5 to 2.0 mu.m is used.

U.S. Pat. No. 4,922,077 to Gordon discloses a method of laser marking metal packages. The laser is controlled in four pass process with the Q-switcing frequency of the laser, the speed at which the laser beam is moved across the package and the width of the lines drawn by the laser being set for each pass.

U.S. Pat. No. 5,072,091 to Nagata, et al. relates to a method and apparatus for processing metal surfaces by forming the fine irregularity patterns which are created by the light interference.

U.S. Pat. No. 5,059,764 to Baer discloses diode-pumped, solid state laser-based workstation for precision materials processing and machining. The laser irradiates a pulse beam having a pulse width of approximately 50 ns or less, which width is necessary for material removal by ablation.

U.S. Pat. No. 5,157,235 to Okumura, et al. proposes a laser marking system which contains device for changing the irradiation positions of the laser beam corresponding to each marking area.

U.S. Pat. No. 5,178,725 to Takeno, et al. discloses a method for working ceramic material which includes an irradiation process of irradiating a laser beam to the base material in order to form an affected portion having cracks and a removing process for removing the affected portion.

U.S. Pat. No. 5,767,483 to Cameron, et al. discloses method of laser marking a body of material having a thermal conductivity approximately equal to that of glass.

U.S. Pat. No. 5,786,560 to Tatah, et al. proposes a method of treating a material by generating an ultraviolet wavelength laser beam having femtosecond pulses.

U.S. Pat. No. 5,966,307 to Lin discloses a laser marker control system which includes a personal computer, a programmable logic control, a movable carrier table, an industrial man-machine interface and a laser device.

U.S. Pat. No. 5,990,444 to Costin describes a laser method and system of scribing graphics. In a preferred embodiment, the material is one of a group of fabric, leather and vinyl materials. In this embodiment, the energy density per unit time can be controlled to substantially avoid complete carbonization, melting and/or burnthrough of the material.

U.S. Pat. No. 6,087,617 to Troitski, et al. discloses computer graphics system for generating an image reproducible inside optically transparent material.

U.S. Pat. No. 6,259,057 to Lai discloses an automatically focusing structure of laser sculpturing machine, including an electronic probe structure vertically mounted on a blade seat of the laser sculpturing machine.

U.S. Pat. No. 6,333,486 to Troitski discloses a method and system for creation of laser-induced images to produce high quality images.

U.S. Pat. No. 6,399,914 to Troitski discloses a method and laser system for production of high quality laser-induced damage images by using material processing made before image creation.

U.S. Pat. No. 6,407,361 to Williams reveals a method for laser engraving a three-dimensional image into a work piece by providing a plurality of pieces of artwork which form a composite three-dimensional image. Each piece of artwork corresponds to a particular layer of material to be removed from the work piece.

U.S. Pat. No. 6,417,485 to Troitski discloses a method and laser system controlling breakdown process development by controlling temporal shape of laser radiation.

U.S. Pat. No. 6,426,480 to Troitski discloses method and laser system for production of high quality single-layer laser-induced damage portraits inside transparent material.

U.S. Pat. No. 6,465,756 to Tanaka describes a method and apparatus in which a laser beam from an portion softening mechanism of an apparatus is condensed onto an portion on an surface of a work piece for softening the portion.

U.S. Pat. No. 6,487,460 to Haeno discloses a laser marker scanning laser beams to print a mark on an object including a laser, an input device designating a mark to be printed, a galvanometer scanner successively receiving coordinate data corresponding to a predetermined location on the object.

U.S. Pat. No. 6,489,985 to Brodsky, et al. describes a laser marking system including a high power fiber laser with a double clad fiber having a doped core surrounded by an inner pump cladding and providing an optical output for marking.

U.S. Pat. No. 6,490,299 to Raevsky, et al. discloses a method and laser system for generating laser radiation of specific temporal shape for production of high quality laser-induced damage images.

U.S. Pat. No. 6,509,548 to Troitski discloses a method and laser system for production of high-resolution laser-induced damage images inside transparent materials by generating small etch points.

U.S. Pat. No. 6,518,544 to Aberle, et al. discloses method for material machining by way of laser wherein a laser beam is led in tracks over a section of a surface to be machined, whereupon the surface is moved in order to bring a neighboring section into the machining field of the laser over which the laser beam is then again led in tracks.

U.S. Pat. No. 6,596,967 to Miesak discloses laser based etching device which modifies the optical properties of an object by using a light beam from a light source that is focused at a first focal point within the object and after is focused at a second focal point to optically change a first and a second locations.

U.S. Pat. No. 6,605,797 to Troitski discloses laser-computer graphic system for generating portrait and 3D sculpture reproductions inside optically transparent material.

U.S. Pat. No. 6,621,041 to Hayashi, et al. discloses marking method and marking apparatus using multiple photon absorption, marked optical element manufactured by using the marking method and the marking apparatus.

U.S. Pat. No. 6,630,644 to Troitski, et al. discloses a method creating damage arrangement for production of 3D laser-induced damage portraits inside transparent materials.

U.S. Pat. No. 6,664,501 to Troitski discloses a method for creating laser-induced color images within three-dimensional transparent media, particularly inside the photosensitive glass.

U.S. Pat. No. 6,670,576 to Troitski, et al. discloses a method for producing images containing laser-induced color centers and laser-induced damages.

U.S. Pat. No. 6,674,043 to Trinks, et al. discloses a method and apparatus for marking glass with a laser wherein the glass is first brought to a temperature above the transformation temperature of the glass. The glass is then acted upon by a laser pulse which produces a mark on the surface of the glass.

U.S. Pat. No. 6,710,287 to Lu discloses laser engraving and coloring method for a golf club head using a laser beam to process on a titanium alloy surface.

U.S. Pat. No. 6,720,521 to Troitski discloses a method and laser system controlling breakdown process development by creation of special space structure of laser radiation for production of high quality laser-induced damage images.

U.S. Pat. No. 6,720,523 to Troitski discloses a method for production of laser-induced images represented by incomplete data, which are supplemented during production.

U.S. Pat. No. 6,727,458 to Smart discloses energy-efficient, laser-based method and system for processing target material. The system includes a device for generating a modulated drive waveform based on the processing control signal.

U.S. Pat. No. 6,727,460 to Troitski discloses a system for high-speed production of high quality laser-induced damage images inside transparent materials by the combination of an electro-optical deflector and means for moving the article or focusing optical system.

U.S. Pat. No. 6,727,463 to Feistel, et al. discloses arrangement for the working of three-dimensional, expandable upper surfaces of work pieces by means of a laser.

U.S. Pat. No. 6,734,389 to Troitski discloses a method and laser system controlling breakdown process development for production of high quality laser-induced damage images by controlling temporal characteristics of laser radiation.

U.S. Pat. No. 6,740,846 to Troitski, et al. discloses a method for production of 3D laser-induced head image inside transparent material by using several 2D portraits.

U.S. Pat. No. 6,768,080 to Troitski discloses a method for production of laser-induced damage images with special characteristics by creating damages of special space shape.

U.S. Pat. No. 6,768,081 to Troitski discloses a method and laser system for production of high quality laser-induced damage images by using material processing made during image creation.

U.S. Pat. No. 6,777,104 to Colea discloses subsurface engraving of three dimensional sculpture wherein laser sculpting steps are performed when the material is still in a gelatinous condition to form small spots in the matrix.

U.S. Pat. No. 6,777,645 to Ehrmann, et al. discloses high-speed, precision, laser-based method and system for processing material of one or more targets within a field.

U.S. Pat. No. 6,788,714 to Benderly discloses laser marking system and method for diamonds wherein a laser beam has a characteristic that is changeable by positioning a selected aperture in the beam within a resonant cavity of a laser source.

U.S. Pat. No. 6,864,457 to Alexander, et al. discloses methods for reducing the adverse effects of particles which become dislodged by scribing and laser machining of materials.

The article “Laser-induced image technology” to Troitski (in Proc. of SPIE, Vol. 5664, 2005) describes methods and systems of laser-induced image technology and ways of their development.

John F. Ready in his monograph “Industrial application of laser”, (Academic Press, 1997) describes the use various kinds of lasers for heating, melting and drilling different material.

The book “Laser Processing in Manufacturing” edited by R. C. Crafer (Chapman & Hall, London, 1993) contains a lot of articles disclosing the industrial application of lasers.

Characteristic feature of all patents and published scientific works is the disclosure of the methods and systems, which can be used either for the creation of laser-induced images on the surfaces of opaque materials or for their production inside transparent materials. These methods and systems use an individual interaction effect from the row of the processes accompanied the laser interaction with material. However, modern laser engineering enables to create the methods and multifunctional systems which can produce laser-induced images by using combination of these effects. Such system can provide two very important modernizations: the first, creation of particular images from marks having different optical characteristics, and the second, creation of the surface and the internal laser-induced images by the same laser machine. The purpose of the present invention is the disclosure of such methods and the multifunctional systems which are capable to produce the laser-induced images both on the surfaces of the opaque materials and inside or on the surfaces of the transparent materials by using marks of different optical properties.

### SUMMARY OF THE INVENTION

The purpose of the present invention is the disclosure of the methods and multifunctional systems which are capable to produce the laser-induced images both on the surfaces of the various (opaque and transparent) materials and inside the transparent materials by using marks of different optical properties. The method and multifunctional system are based on using different kinds of the laser-material interaction such as heating, melting, vaporization, material removal by shock waves, breakdown and photoionization. The method and system can also use a combination of the interaction effects and create images containing marks of different optical properties. In particular, the method includes selection of the needed kinds of the laser-material interaction, determination of laser radiation parameters for generation of the desirable interaction kind and the transformation of the given image into the point arrangements determining the location of the marks and their needed optical characteristics.

One or more embodiments of the invention comprise a method for the production of laser-induced images on the surfaces and inside materials, comprising: selection of the kinds of laser-material interaction necessary for the creation of the desirable laser-induced images; determination of laser-radiation parameters for generation of the needed interaction; transformation of the given image into the arrangement of the interaction points; generation of the laser radiation, direction and focusing it at the predetermined material areas; controlling laser parameters and coordinates of focal spots for generation of needed interaction at the predetermined surface or internal material areas. Another embodiment of the invention comprises a system which provides the production of laser-induced images on the surfaces and inside materials by using combination of laser-material interaction effects. The system contains: preproduction analysis system; computer graphic system; laser radiation system; beam transmission and delivery system; system for shifting material; control system.

### DESCRIPTION OF THE DRAWINGS

FIG. 1 illustrates in block-diagram form a laser-computer system for production of laser-induced images on surface of various (opaque and transparent) materials and inside transparent materials, comprising: preproduction analysis system; computer graphic system; laser radiation system; beam transmission and delivery system; system for shifting material, and control system.

FIG. 2 shows the portrait which is suggested for production on surfaces of metal, stone, ceramic and inside a crystal.

FIG. 3 shows a point arrangement corresponding to the portrait of FIG. 2 for production of the surface image. The point arrangement reproduces 17 gray shades by the modulation of the point density. This arrangement is modified for producing an image inside a crystal so that four point arrangements shown in FIGS. 4-7 are generated.

FIGS. 4-7 show four point arrangements produced from the point arrangement of FIG. 3 carried out for producing portrait of FIG. 2 inside a crystal.

FIG. 8 is a photo of the portrait produced on the metal (Aluminum) surface by Nd:YAG laser.

FIG. 9 is a photo of the portrait produced inside a crystal by Nd:YAG laser.

FIG. 10 is a photo of the portrait produced on a surface of a ceramic plate by Nd:YAG laser.

FIG. 11 is a photo of the portrait produced on a surface of a stone (granite) plate by Nd:YAG laser.

### DETAILED DESCRIPTION OF THE INVENTION

The invention comprises a method and multifunctional system for producing 2D laser-induced images on the surface of various (opaque and transparent) materials and 2D and 3D laser-induced images inside the transparent materials.

The principal concepts of the invention are based on the generation and the control of the physical processes accompanying the interaction of laser radiation with the opaque and transparent material so that effects created by this interaction produce the local modification of the optical characteristics of the surface and/or internal material areas. Mention of the general physical peculiarities of the interaction effects, which are important for the production of the surface and internal laser-induced images, is useful for understanding the methods of the present invention.

When laser radiation strikes a surface of opaque (or partly opaque) material, part of the radiation is absorbed and part is reflected. The energy that is absorbed begins to heat the surface. The heating effects due to absorption of high-power beams can occur very rapidly and the area of the surface, where laser radiation is focused, quickly rises to its melting temperature. If the laser pulse duration is very short then melting occurs without vaporization and laser interaction occurs only with very thin layer of the surface. Stretching the pulse length, it is possible to vaporize the part of the material and to melt the thicker layer.

From point of view of creating surface laser-induced images, it is important that, heating, melting and vaporization effects together with the simultaneous control of the laser radiation power and the pulse duration provide the controlling change of optical characteristics of the surfaces. Large number of the effects gives rise to different kind of the changes that accomplishes production of the image of various properties. If a drop of melting material after hardening has reflecting characteristics differing from the original material, then the laser-induced image can be created by laser pulse of short duration.

Production of laser-induced images on polish surfaces is reasonable by creation of small lusterless areas. Such areas can be produced by vaporization of the material from these surface areas. For a given total energy in the laser pulse, it is often desirable to stretch the pulse duration. If the laser pulse duration is very short, then thermal conduction is small and only very thin layer of surface interacts with the laser radiation. Consequently, in this case the laser-induced images have small thickness. Creation of the relief surface images demands vaporization of the material from the areas placed on different thickness that can be produced by controlling the pulse energy and the pulse duration, so that deeper areas are treated with pulses of larger energy and longer duration.

The depths of the relief image fragments are proportional to the pulse duration, the absorbed irradiance and inversely proportional to the latent heat of vaporization and the density of the material. For example, laser-induced images on metal surface with low heat of vaporization have deeper relief than images produced by the same laser radiation on metal with high heat of vaporization. During laser-induced image creation, not all of the ejected material is vaporized. The vapor builds up a pressure that causes a material flow. This flushing process removes some of the material as unvaporized droplets of. molten material and results in a mass removal that is larger than if only vaporization occurred. This effect can be useful and can be harmful for creation of laser-induced images: it is useful for production of large surface images and it is harmful for creation of small images of high resolution. Indeed, in the last case, if special actions are not undertaken than the droplets of molten material subside on the surface and destroy the adjacent structure.

The amount of material that can be removed during a laser pulse depends on the material processed and how efficiently the energy of the laser pulse is converted into the removal of the material.

The dominant process in material removal by laser may often be simple vaporization with absorption of the laser energy at a continually retreating surface. The vaporized material can simply diffuse away into the surrounding atmosphere, without further interaction with the beam. Other mechanisms that can increase the amount of material removal are flushing of liquid material and particulate emission because of subsurface explosions. Absorption of laser energy in the blow off material can shield the surface and reduce the amount of material removal.

Under some conditions, most of the material may be removed as liquid. For example, for laser radiation with 30 kW generated by Nd:YAG laser, early in the pulse, most of the material is removed as vapor, but after a few hundred microseconds, about 90 percent of the material removal occurs as liquid droplets (John F. Ready, Industrial Applications of Lasers, Second Edition, Academic Press, 1997).

One of the methods which provide increasing material removal during the creation of the relief surface images is the repetition of laser pulses at the same material point. More number of laser pulses focused at the same surface area deepens this area.

Determining the optimal pulse duration for production of surface laser-induced images by material removal, it is necessary to take into account the shielding effect. Early in the laser pulse, some material is vaporized from the surface. The vaporized material is slightly thermally ionized and absorbs some of the incident light. This heats the vapor more, producing more ionization and more absorption in a feedback process. Rather, the vaporized material does interact and absorb the incoming laser beam, so that the surface is shielded from the laser light.

Another important parameter that affects laser-induced image production is the reflectivity of the material surface. It defines the fraction of the incident light that is absorbed and contributes to heating effects. The reflectivity is a function of the material, the quality of its treatment and wavelength. For example, copper has low reflectivity in the blue portion of the visible spectrum and a relatively high value in the red portion. It means that radiation with wavelength around blue is preferable for production images on copper surfaces. Ferrous metals (steel and nickel) have typically low reflectivity through the visible spectrum so that any radiation of visible spectrum is well suited for production of images on their surfaces.

In the general case, for production of surface laser-induced image is very important both the duration and the temporal shape of the laser pulse. Control of the temporal shape of the laser radiation provides production of surface images by generating different interaction effects. Shapes and sizes of marks on the opaque surfaces can be controlled by the irradiation of the surface by the laser beam, which at the beginning has small power and after the surface is heated it has very high power during very short time. Shapes and sizes of marks inside transparent material can be controlled by focusing laser beam, which at the beginning has very high power during very short time to create small damage and after it has small power to maintain the laser-induced plasma to create the accurate damage of the desirable sizes.

Another very important property of laser radiation which can be used for controlling interaction process for creation of the surface image of the desirable quality is the space structure of the laser radiation. Small marks generated by heating, melting, vaporization, photoionization and breakdown are produced single mode laser radiation. However, it is reasonable for production of laser-induced images on large surfaces of material (stone, metal, glass) to use accurate enough large marks. Such marks can be produced by multimode laser radiation. A focal area of such radiation has many brightness centers which creates a very accurate lusterless structure inside the focal area.

A. B. May describes (“Continuous wave and Q-switched Nd:YAG lasers” in Laser Processing in Manufacturing, Edited by R. C. Crafer, Chapman & Hall, London, 1993) that below the melting point, non metals can show a color change. At the melting point many metals show a change in color and reflectance. Steel, gold and brass become dark brown or black. Non-metals often form a groove as material is displaced; changes in surface texture and/or color change are common. At vaporization, surface layers can be removed cleanly (for example, paint, ink or anodizing), which can expose the base material giving very high contrast. Most metals and many plastics vaporize giving holes or grooves.

Effects mentioned above and used for creation of surface laser-induced images are generated only during interaction of laser radiation with opaque material. Materials which are transparent for used laser radiation do not absorb and reflect the radiation and therefore it is not possible to create surface images by using described effects. In this case the breakdown effect plays the key role in creation of surface and internal images.

The laser-induced breakdown is generated inside transparent material when laser radiation increases the breakdown threshold, the value of which depends on the treated material. A number of methods and systems for creation of laser-induced images inside transparent materials by using breakdown effects are disclosed in patents mentioned above. Now it is important to pay the attention on the possibility to use the effect for creation of surface images both on opaque and transparent materials.

Laser-induced breakdown generated by pulsed laser radiation is accompanied by very bright sparks, which can be created inside air or another gas surrounding the material, on which the image is produced. The sparks contain the very hot plasma with temperature of several thousands of degrees and their generation is accompanied by strong shock wave directed from the spark area. Usually, the breakdown into the air near surfaces is generated at lower values of laser irradiance than far from the surfaces.

Thus, focusing laser radiation at air points near the surfaces of opaque or transparent materials, it is possible to create small sources of high temperature and of the strong shock waves, which are able to change local characteristics of the surfaces. These surface marks are used for creation of surface laser-induced images.

Another kind of laser interaction, which can be used for creation laser-induced images on the surface or inside materials, is effect of photoionization. Photoionization of glasses leads to the creation of laser-induced color centers, which are generated by laser pulses at irradiance below the thresholds of laser-induced breakdown.

Relief surface laser-induced images on transparent material can be created by directing laser beam from the back of the work piece and focusing it to the opposite inner surface. In this case, the evaporated transparent material can freely flow away and hot opaque plasma does not shield the material from the laser beam.

Usually, laser-induced image inside transparent material is created as an arrangement of the separated marks. Additionally, laser-induced image inside transparent material can be created by separated curves of different thickness. The curves are created by overlapping marks and can work as optical fiber. The fibers can have rough external and internal structures which reflect the external and internal light. The last factor provides creation of bright and color images by illuminating these channels (fibers) with corresponding light or by filling them with corresponding color liquid.

Another method for production of laser-induced images by creating special conditions for light transmission is based on the local modification of transparent material refractivity as a result of its interaction with femtosecond laser pulses, the energy values of which are below the breakdown threshold. This effect can be used for creation of laser-induced images by local modulation of refractivity of the transparent material in accordance with the given images. As a result of this processing, the created image can be invisible in the natural light, but it becomes visible by using the special color light passing along the refractivity modification of the transparent material.

One or more embodiments of the invention comprise a method for production of laser-induced images on surfaces and inside materials by using combination of effects of laser-material interaction, comprising:
selection of the kinds of laser interaction necessary for creation of the desirable laser-induced image;
determination of laser-radiation parameters for generation of needed interaction;
transformation of the original image into arrangement of interaction points;
generation of laser radiation, direction and focusing it at the predetermined material areas;
control of laser parameters and coordinates of focal spots for generation of needed interaction at predetermined surface or internal material areas.

The kind of laser-material interactions including heating, melting, shock waves, vaporization, the laser-induced breakdown and photoionization is selected in dependence upon the characteristics of the marks needed for producing images of desirable properties and quality. Heating the surface areas by focusing laser beam at these areas provides the change of color of some non metal surfaces if their temperature is enough high but below melting temperature. At the melting point, some metal surfaces change color and/or background reflectance (steel, gold and brass become dark brown or black). Shock waves and melting provide changing background reflectance of polished surfaces by creating lusterless areas. Vaporization provides material removal and is used for creating thin layer surface images. Joint action of melting and vaporization is used for production of relief surface images, which can be also created by joint action of melting and shock waves. Controlling the removal process, it is possible to remove different material amount for various areas. Focusing laser beam at the predetermined areas of the material and creating the conditions for photoionization phenomenon provide the production of absorbing marks. Breakdown phenomenon provides creation of reflecting marks on surface and inside transparent material. A composition of several (two or more) interaction effects from the effects like heating, melting, vaporization, shock waves, breakdown and photoionization provides the production of images containing marks of different properties (color, absorbing, reflecting and lusterless marks) and gives a chance to create images on surfaces and inside materials.

Accordance to the discussed method after selection of the interaction kind (or a combination of the interaction kinds) which provides the production of desirable properties marks, it is necessary to determine the laser radiation parameters, which generate the needed laser-material interaction (or the corresponding their combination). The laser radiation parameters which determine the desirable interaction kind (or their combination) are the wavelength, temporal characteristics, space structure, temporal shape, pulse duration, power density and total energy. The wavelength of laser radiation used for mark creation by heating, melting and vaporization is selected so that the treated material is opaque (or partly opaque) and has low reflectivity for the radiation of the wavelength. The wavelength of laser radiation used for damage creation by the breakdown is selected so that the material is transparent (or partly transparent) for the wavelength. Parameters of the laser radiation which are responsible for production marks by heating below the melting, at the melting points and by the vaporization are the wavelength, total pulse energy and pulse duration. Selecting the values of these parameters, it is possible to generate the corresponding kind of the interaction. The pulse duration, total pulse energy and the number of pulses directed at the same area are selected so that the desirable amount of material is removed and the given surface area is produced on the needed depth. The same parameters of laser radiation determine the sizes of marks produced by all kinds of the interaction: the longer pulse duration, higher pulse energy and larger number of pulses produce laser-induced marks of larger sizes. The space structure of laser radiation determines the characteristics of marks: single mode radiation creates small surface marks with smooth internal structure; the multimode radiation creates larger surface marks with lusterless structure.

The temporal shape determines the quality of the surface and internal marks. The accurate surface marks are created by the laser radiation which at the beginning has small power density and after it is very power short pulse. The accurate internal marks are created by the laser radiation which is a short power pulse at the beginning but after it has essentially smaller power during essentially longer period. Photoionization effects are generated by pulse laser radiation which has high energy, but smaller than breakdown threshold. The pulse laser radiation with energy which increases the breakdown threshold provides the production of laser-induced damages inside transparent materials. The damages are visible because they reflect external light. Higher energy laser radiation creates higher reflected damages.

Selecting and controlling laser radiation parameters it is possible to create surface and internal images by using the composition of several interaction effects from the effects like heating, melting, vaporization, breakdown and photoionization. As a result of this it is possible to create images containing marks with different optical properties. For example, using the same laser radiation but only changing pulse energy it is possible to produce 3D image containing color centers and damages: color centers absorbing light are created by pulse energy below breakdown threshold; damages reflecting color are created by pulse energy above breakdown threshold. Another example is production surface and internal image. As it will be disclosed below, the radiation generated by Nd YAG laser provides production of surface images on stone, metal and inside crystal.

The transformation of the given image into an arrangement of the interaction points is produced so that laser radiation of the predetermined parameters focused at the areas of the said points creates the changes of the material which reproduce the surface and internal images of the needed quality. The principal difference between a point arrangement used for producing an image on opaque surfaces and a point arrangement used for producing an image inside transparent materials like crystals is that the distances between adjacent points on the opaque surfaces can be equal to zero, but the distances between adjacent points inside transparent materials cannot be smaller the minimal value (otherwise internal crash of transparent material arises). Therefore, at the beginning, a point arrangement for creating the surface image on an opaque material is created and after the said point arrangement is modified so that the distances between adjacent points are larger the minimal value determined for used transparent material. This modification can be produced by one of three ways. The first way: the adjacent points of the point arrangement created for a surface image are carried into adjacent collinear layers the distances between which are larger than the minimal distance. The second way: the point arrangement created for a surface image is stretched uniformly along both axes so that distances between adjacent points become larger the minimal distance. The third way: the part of adjacent points is removed so that distances between others are larger the minimal distance.

The base for creation of point arrangement is the arrangement of pixels of the original image. However it is important to take into account that if the surface marks created by the laser beam are brighter than the original surface then the pixels of the given image should be used, but if the original surface is brighter than these marks then the pixels of the negative replica of the given image should be used. Sometimes, comparative brightness of a surface and the marks is changed depending on the viewing angle and in this case the point arrangement carried out on the base of the negative replica reproduces an image which looks as right or negative copy depending on the observation angle.

A point arrangement is created so that the reproducible image can be 2D, 3D or graph image containing complicated 2D and 3D curves. Such point arrangement describes both placement of the points and characteristics of the material changes which correspond to the points used for production of the given image of the needed quality. The space resolution of reproduced image is determined by the sizes of the points contained at the said interaction point arrangement. This arrangement of interaction points created for the generation of images by using heating, melting, vaporization and photoionization reproduces the needed number of gray shades by modulation of the space density of the interaction points or by modulation of the brightness of these points. Transformation of 3D image into 3D point arrangement is produced by two stages: at the beginning 3D model is created and after this 3D model is covered by the points at which the predetermined laser-material interaction is generated.

A system which provides the production of laser-induced images on surfaces and inside materials by using combination of laser-material interaction effects comprises:
preproduction analysis system;
computer graphic system;
laser radiation system;
beam transmission and delivery system;
system for shifting material;
control system.

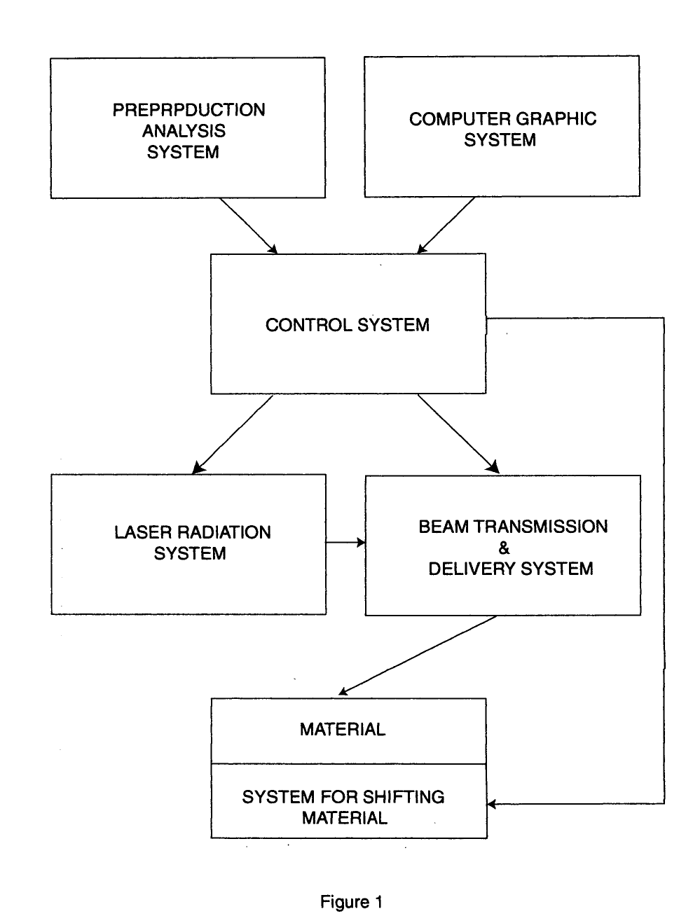

FIG. 1 illustrates in block-diagram form this laser-computer system. Preproduction analysis system processes the receiving information (image and material on which or inside which the image should be produced), selects the kind (or combination of kinds) of the laser-material interaction (heating, melting, vaporization, material removal by shock waves, the breakdown or photoionization) which can be used for the desirable image reproduction, and determines the parameters of laser radiation which generates the selected kind of interaction. Computer graphic system transforms the given image into arrangements of interaction points for production of surface and/or internal images. Laser radiation system generates laser beam with predetermined parameters. Beam transmission and delivery system provides directing and focusing laser radiation at the areas corresponding to interaction point arrangement of surface and/or internal images. A system for the replacement of the material helps to the delivery system for focusing the beam at the predetermined material points. Control system controls laser radiation parameters for generation of selected kind of laser-material interaction for each area of the point arrangement.

### EXAMPLE 1

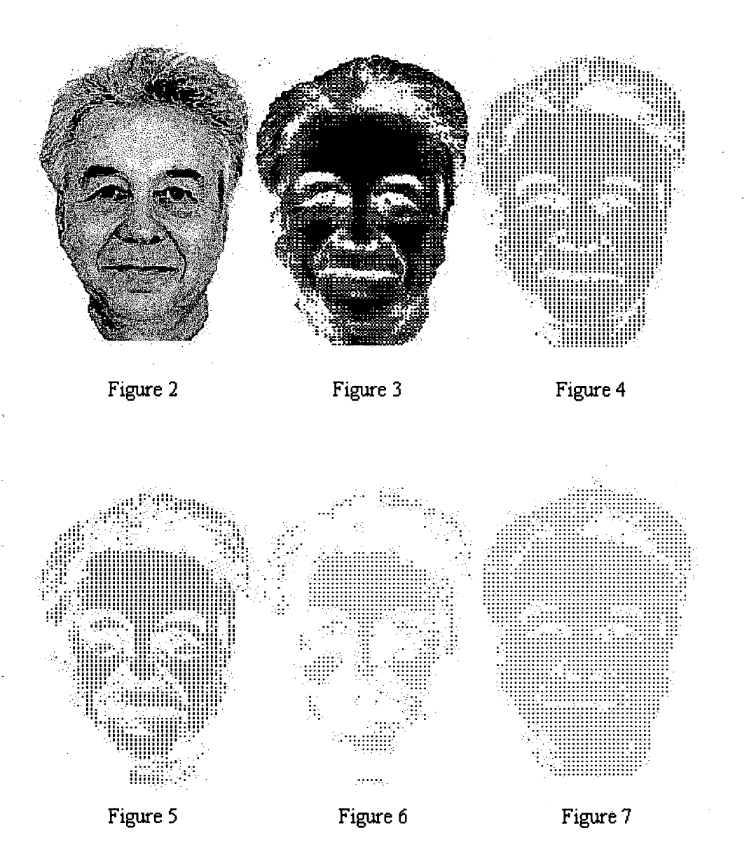

Let us imagine that the portrait shown on FIG. 2 should be reproduced on metal, stone, ceramic plate and inside a crystal by using laser radiation.

Step 1. Selection of laser-material interaction kinds which can be used for production of the portrait on metal, stone, ceramic, and inside crystal.

The booked surface images can be produced by using material removal generated by melting, vaporization and shock waves; the needed image inside crystal can be produced by the breakdown phenomenon.

Step 2. Determination of laser parameters for generation of the kinds of laser-material interaction selected on step 1.

For production of demanded surface images, it is necessary to use the laser radiation which is enough high absorbed by the metal, stone, ceramic and for which a crystal is transparent. One from the various radiations which are suitable for this task is the green wavelength. Pulse energy and pulse duration are used so that energy at the focal area has value increasing the threshold of the used kind of laser-material interaction. For a metal with thermal diffusivity 0.25 cm²/sec, heat can penetrate only about 3×10⁻⁴ cm during a pulse of 20-90 nsec duration (typical of a Q-switched laser). During a pulse of 100 μsec duration (typical of a normal pulse laser) heat can penetrate about 0.01 cm into the same metal. Hence, the creation of thin surface images is provided by Q-switched mode laser regime; the creation of the relief surface images is provided by free-running mode regime.

Early in the Q-switched laser pulse (30 nsec duration), the surface starts to vaporize. Then the vaporized material heated and ionized by the laser forms hot, opaque, ionized plasma, which absorbs essentially the entire incoming laser light. Finally, late in the pulse, the plasma has expanded and become transparent again. Light can again reach the surface, and some additional material is vaporized. Because of these effects, the amounts of material that can be removed by short-duration, high-power pulses are limited. Larger pressure pulses are developed when the LSA wave is kindled. The hot plasma, as it expands, can drive a shock wave into the target. Peak shock pressures of ten of kilobars have been measured in metallic materials irradiated by high-power Q-switched laser.

The Q-switched laser pulse is also suitable for creation laser-induced images inside crystals by using breakdown phenomenon.

Step 3. Selection of a laser which generates the radiation with parameters determined by step 2.

Accordance to results of step 2 one of the laser suitable for production of needed images is Nd: YAG laser generating second harmonic. Production of thin surface images and images inside crystals can be fabricated by Q-switched mode laser regime. Combination of production of thin surface and relief images can be provided with combination of two generation regimes of Nd:YAG laser (Q-switched mode and free-running mode) disclosed in U.S. Pat. No. 6,490,299 to Raevsky & Troitski.

An example of another laser which can be also used for this production is a pulsed copper vapor laser system generating green light with wavelength 510.554 nm and yellow light with wavelength 578.213 nm.

Step 4. Transformation of the original image into arrangement of interaction points.

Transformation of the given portrait into arrangement of interaction points for its reproduction on surfaces of metal, stone, ceramic and inside the crystal is produced in accordance with methods disclosed above. The transformation has two steps: the first is creation of point arrangement for the production of the surface images and the second is modernization of the said point arrangement into the new point arrangement so that distances between its adjacent points are larger than the minimal distance.

Step 5. Generation of laser radiation, directing and focusing it at the areas corresponding to points of point arrangement determined on the step 4.

In accordance with the steps determined above the system for production of the images is analogous the system of FIG. 1 and comprises: preproduction analysis system, computer graphic system, laser radiation system, beam transmission and delivery system, and control system. Preproduction analysis system selects the kinds of laser-material interaction which can be used for the production of booked images, determines laser parameters for generation of the needed laser-material interaction, and selects a laser which generates the radiation with the predetermined parameters. Computer graphic system transforms the given image into arrangement of points at which laser-material interaction is produced. The said point arrangements are created for production of both surface and internal laser-induced images. Laser radiation system generates the radiation with parameters predetermined by the preproduction analysis system. Beam transmission and delivery system provides the delivery of the laser beam to the material areas corresponding to the points of the point arrangements created by the computer graphic systems. Beam transmission and delivery system includes optical systems and a system for shifting material. Control system controls the production process including changing laser parameters during image production and the delivery of the laser beam at the areas corresponding to the arrangement points.

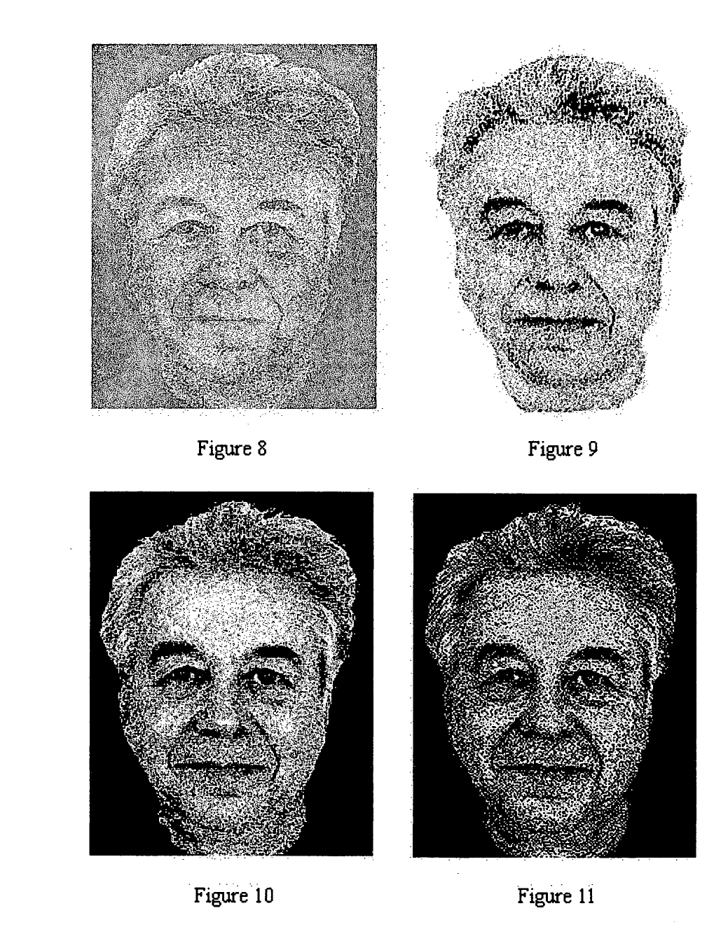

FIG. 2 shows the portrait which is suggested for production on surfaces of metal, stone, ceramic and inside a crystal. FIG. 3 shows a point arrangement corresponding to the portrait of FIG. 2 for production of the surface images. The arrangement reproduces 17 gray shades by modulation of point density. This arrangement is modified for producing an image inside a crystal in four point arrangements shown in FIGS. 4-7. FIG. 4 (analogously FIGS. 5-7) shows one of four point arrangements created from the point arrangement of FIG. 3. Jointly these four point arrangements are used for production of the portrait inside a crystal. Each point arrangement is produced in separate layer. FIG. 8 is a photo of the portrait of FIG. 2 produced on the metal (Aluminum) surface by Nd:YAG laser. FIG. 9 is a photo of the portrait produced inside a crystal by Nd:YAG laser. FIG. 10 is a photo of the portrait produced on a surface of a ceramic plate by Nd:YAG laser. FIG. 11 is a photo of the portrait produced on a surface of a stone (granite) plate by Nd:YAG laser.

Disclosed system is the stationary, hands-free system, the sizes of which depend on the laser parameters and workplace sizes. Another particular of the system is that an artist does not take part in the production process directly but only through the graphic computer system. Accordance to the process, an artist creates the image and can take creative part in the transformation of the image into 2D or 3D arrangement of points. After that an artist is viewing the image creation process. However, for the true artist, it is very important to have an opportunity to participate in the image creation process and to develop art image by his own hands. In this case, the laser radiation device should be small, relatively light and convenient for the manual image production. This purpose can be reached by the combination of two conditions: the first, miniaturization and special construction of the system, by picking out and separating the general part of the generation system from the auxiliary parts, and the second, automatic focusing the laser beam. The last condition is important because a painter works on 2D picture and does not have the experience to use a brush, the action of which depends on the distance between the brush and the surface of the material. An example of automatically focusing structure of laser sculpturing machine is described in U.S. Pat. No. 6,259,057. This device includes an electronic probe structure vertically mounted on a blade seat of the laser sculpturing machine. More suitable automatic focusing method for production of the surface laser-induced images is the use of an additional low power radiation which is focused by the same optics so that the focal spot sizes of this low power radiation gives complete information about focal spot of the general radiation. Every automatic focusing system should provide the indication of the depth of each mark. This information is general for the production of 3D images inside the transparent material by a manual system, because of the light refraction, which distorts the visible estimation of the mark depth.

One or more embodiments of the invention comprise a system for manual production of laser-induced images on surface and inside materials, comprising:
portable laser radiation system;
portable power supply;
portable battery (accumulator);
forming optical system;
automatic focusing system;
system for controlling laser radiation parameters.

Portable laser radiation system, portable power supply and portable battery (accumulator) are the result of picking out and separation of the regular laser radiation system. Portable laser radiation system comprises work body, resonator and portable forming optics. Portable power supply and portable battery are placed in special bag separated from the laser radiation system. Portable power supply can also work without battery by using stationary electro source. Forming optical system has exchangeable lenses with different focal lengths. Automatic focusing system provides automatically focusing the general laser radiation on the surface and inside treated material. The portable laser radiation system combined with the forming and focusing optics is a manual laser device. This laser device is constructed so that it is convenient for hand working. An artist works with this device like a pencil but has opportunity to create image on surface and inside materials by moving the laser device along the material, drawing near and distancing. Another version of creating handy manual system for producing laser-induced images is the use of output fiber delivery system completed with focusing optics. For example, it can be a pulsed ytterbium fiber laser having long output fiber delivery system.

The great advantage of the manual system is that it gives a laser pencil using of which an artist is able to develop his creative activity during creation of the 2D surface and internal 3D laser-induced images.

I claim:

1. Method for production of laser-induced images on surfaces and inside materials by using combination of laser-material interaction effects, comprising:
selection of the kinds of laser-material interaction effects necessary for creation of the desirable laser-induced images;
determination of laser radiation parameters for generation of needed laser-material interaction;
transformation of the given image into arrangement of interaction points;
generation of laser radiation, direction and focusing it at the predetermined material areas;
control of the laser parameters and coordinates of focal spots for generation of needed laser-material interaction at the predetermined surface or internal material areas.

2. A method in accordance with claim 1, wherein the kind of laser-material interaction effects, including heating, melting, vaporization, the laser-induced breakdown, photoionization and local refractivity modulation are selected in dependence upon the characteristics of the marks needed for producing images of desirable properties and quality.

3. A method in accordance with claim 2 wherein the marks used for laser-induced image production are generated by modification of color of some non metal surfaces by focusing laser beam at the predetermined areas of the material and heating the areas below melting temperature.

4. A method in accordance with claim 2 wherein the marks used for laser-induced image production are generated by modification of color and/or background reflectance of some metal surfaces are produced by focusing laser beam at the predetermined areas of the material and heating the areas at the melting temperature.

5. A method in accordance with claim 2 wherein the marks used for production of thin-layer laser-induced images are generated by focusing the laser beam at the predetermined areas of the material and vaporizing the material of the areas.

6. A method in accordance with claim 2 wherein the laser-induced marks for production of relief surface images are produced by focusing laser beam at the predetermined areas of the material for the removal of the part of the material from these areas.

7. A method in accordance with claim 6 wherein the amount of the material removed from the various areas can be different.

8. A method in accordance with claim 6 wherein the removal of the material from its area is produced by focusing laser radiation at the region of the area and creating the conditions for vaporization or strong shock waves.

9. A method in accordance with claim 6 wherein the removal of the material for production of the surface images is produced by joint action of melting and vaporization so as part of the material is removed as liquid and the part of the material is removed as vapor.

10. A method in accordance with claim 6 wherein the removal of the material for the creation of the relief surface laser-induced images is produced by joint action of melting and vaporization.

11. A method in accordance with claim 6 wherein the relief surface laser-induced images are created without plasma shielding by focusing the laser beam to the opposite inner surface.

12. A method in accordance with claim 2 wherein creation of absorbing marks is produced by focusing laser beam at the predetermined areas of the material and creating the conditions for photoionization phenomenon.

13. A method in accordance with claim 2 wherein reflecting marks for surface and internal laser-induced images are created by the breakdown phenomenon.

14. A method in accordance with claim 2 wherein production of laser-induced images is provided by creating special conditions for light transmission inside transparent material.

15. A method in accordance with claim 14 wherein special conditions for light transmission inside transparent material are created by the local modification of the transparent material refractivity.

16. A method in accordance with claim 15 wherein the local modification of the refractivity for producing laser-induced images is created by the femtocecond laser pulses with the energy below breakdown threshold.

17. A method in accordance with claim 1 wherein modification of the material characteristics for creation of laser-induced images is produced by a composition of several (two or more) interaction effects from the effects such as heating, melting, vaporization, breakdown, photoionization and local modulation of refractivity.

18. A method in accordance with claim 1 wherein laser radiation parameters including the wavelength, temporal characteristics, space properties, temporal shape, pulse duration and energy characteristics are selected so that the interaction of laser radiation with the processed material generates the needed changes of the material which can be used for reproduction of laser-induced images.

19. A method in accordance with claim 18 wherein the wavelength of laser radiation used for the creation of surface marks by heating, melting and vaporization is selected so that the material is opaque (or partly opaque) and has low reflectivity for the radiation of this wavelength.

20. A method in accordance with claim 18 wherein the wavelength, pulse energy and pulse duration are selected so that marks are produced by the heating below the melting temperature.

21. A method in accordance with claim 18 wherein the wavelength, pulse energy and pulse duration are selected so that marks are produced by the heating at the melting point.

22. A method in accordance with claim 18 wherein the wavelength, pulse energy and pulse duration are selected so that marks are produced by the vaporization.

23. A method in accordance with claim 18 wherein the pulse energy and pulse duration are selected so that each mark is produced at the needed depth of the material surface.

24. A method in accordance with claim 18 wherein the desirable depth of each surface mark area is produced by directing the corresponding number of pulses at the said area.

25. A method in accordance with claim 18 wherein conditions for photoionization effects are created by using pulsed laser radiation of corresponding wavelength with pulse energy below breakdown threshold.

26. A method in accordance with claim 18 wherein wavelength of laser radiation used for damage creation by the breakdown is selected so that the material is transparent (or partly transparent) for the laser radiation of this wavelength.

27. A method in accordance with claim 18 wherein damages inside transparent materials are generated by focusing pulse laser radiation so that the energy at the mark areas increases the breakdown threshold corresponding to the used material.

28. A method in accordance with claim 18 wherein wavelength, pulse duration and pulse energy of laser radiation are determined so that local modulation of the refractivity can be used for production of laser-induced images inside transparent materials.

29. A method in accordance with claim 18 wherein the composition of several laser-material interaction effects from the effects such as heating, melting, vaporization, breakdown and photoionization can be generated for production of surface and internal images by the laser radiation of the same parameters.

30. A method in accordance with claim 18 wherein the pulse energy, pulse duration, temporal shape, space structure of laser radiation and the number of pulses directed at the same area determine the sizes of the marks generated by heating, melting, vaporization, photoionization and breakdown.

31. A method in accordance with claim 1 wherein transformation of the given image into arrangement of interaction points (point arrangement) is produced so that the said point arrangement can be used for production of both surface and internal laser-induced images.

32. A method in accordance with claim 31 wherein the said point arrangement is produced so that the laser radiation of the predetermined parameters focused at the areas of the points of the said point arrangement creates the changes of the material which reproduce the said image of the needed quality.

33. A method in accordance with claim 31 wherein the said arrangement of interaction points describes both the placement of the points and characteristics of the material changes which reproduce the given image of the needed quality.

34. A method in accordance with claim 31 wherein the space resolution of the reproduced image is determined by the sizes of the points contained at the said point arrangement and by the total number of these points.

35. A method in accordance with claim 31 wherein the said arrangement of interaction points created for the generation of images by using heating, melting, vaporization and photoionization reproduces the needed number of gray shades by modulation of the space density of points contained in the interaction point arrangement.

36. A method in accordance with claim 31 wherein the said arrangement of interaction points created for the generation of images by using heating, melting, vaporization and photoionization reproduces the needed number of gray shades by the modulation of the number of pulses directed at the different points.

37. A method in accordance with claim 31 wherein the said arrangement of interaction points for the reproduction of an internal image inside transparent materials by using breakdown is generated from the arrangement of interaction points created for the generation of the image by heating, melting, vaporization and photoionization so that distances between adjacent points increase the minimal distance.

38. A method in accordance with claim 31 wherein the said point arrangement is created so that reproducible image can be 2D, 3D or graph image containing complicated 2D and 3D curves.

39. A method in accordance with claim 31 wherein transformation of 3D image into 3D point arrangement is produced by two stapes: the first step is creation of 3D model; the second step is covering the 3D model by the points at which should be produced laser-induced marks.

40. A method in accordance with claim 31 wherein transformation of the given image into point arrangement is based on the original image or it's the negative copy depending on the relative brightness of the surface and the marks created by the used laser-material interaction.

41. System for production of laser-induced images on surfaces and inside materials by using combination of effects of laser interaction with the materials, comprising:
preproduction analysis system;
computer graphic system;
laser radiation system;
beam transmission and delivery system;
system for shifting material;
control system.

42. A preproduction analysis system in accordance with claim 41 wherein the needed kinds of the laser-material interaction and corresponding parameters of the laser radiation providing the needed kinds of the said interaction are determined so that the laser-induced image is produced on and/or inside the booked materials with the desirable quality.

43. A computer graphic system in accordance with claim 41 wherein transformation of the given image into arrangement of points, at which the predetermined laser-material interaction is generated, is created so that the given image can be produced on and/or inside the booked materials with the desirable quality.

44. A laser radiation system in accordance with claim 41 wherein laser radiation is generated with the parameters providing the predetermined kinds of the laser-material interaction for production of surface and internal laser-induced images.

45. An apparatus in accordance with claim 44 wherein the means for generating laser radiation for production of laser-induced images on surfaces of various opaque materials and inside transparent material includes a Nd:YAG laser.

46. An apparatus in accordance with claim 44 wherein the means for generating laser radiation for production of laser-induced images on surfaces of various opaque materials and inside transparent material includes a pulsed copper vapor laser system.

47. System for manual production of surface and internal laser-induced images, comprising:
portable laser radiation system;
portable power supply;
portable battery (accumulator);
forming optical system;
beam delivery system;
automatic focusing system;
system for controlling laser radiation parameters.

48. An apparatus in accordance with claim 47 wherein the means for generation of laser radiation are separated so that work body and resonator with portable forming optics are the united system comfortable for manual production of laser-induced images.

49. An apparatus in accordance with claim 47 wherein the means for beam delivery includes the long output fiber delivery system completed with focusing optics using for manual production of laser-induced images.

50. An apparatus in accordance with claim 47 wherein the means for automatic focusing system indicates the depth of each mark produced inside the transparent material.
